(19) United States
(12) Patent Application Publication
(10) Pub. No.: US 2018/0054868 A1
(43) Pub. Date: Feb. 22, 2018

(54) Dual-output driver for brightness dimming and color tuning

(71) Applicant: SHANGHAI HUXING TECHNOLOGY CO., LTD., Shanghai (CN)

(72) Inventors: Xiaofang YAN, Shanghai (CN); Wufeng TANG, Shanghai (CN)

(21) Appl. No.: 15/596,413

(22) Filed: May 16, 2017

(30) Foreign Application Priority Data
Aug. 16, 2016 (CN) 201620882958.2
Nov. 7, 2016 (CN) 201610975132.5

(51) Int. Cl. H05B 33/08; H05B 37/02

(52) U.S. Cl. CPC H05B 33/0857; H05B 37/0263; H05B 33/0809; H05B 33/0845

(57) ABSTRACT

A dual-output driver uses two constant-current driver circuits to provide two modulated-current signals to two LED modules arranged to output lights of different color temperatures. Each of the constant-current drivers receives a dc voltage from a dc power source and a pulse-width modulation (PWM) signal. The PWM signals, PWM1 and PWM2, are provided by a voltage-to-PWM converter, which uses a single-chip microcomputer or the like programmed to sample the output voltage of a variable voltage source to generate the PWM signals. The variable voltage source can be a single 0-10V dimmer or two 0-10V dimmers. One LED module is arranged to provide output light of 3000 K and one is arranged to provide output light 6500 K. The mixed light from the two LED modules has color temperatures between 3000 K and 6500 K depending on the ratio of PWM1:PWM2.

### CROSS REFERENCE TO RELATED PATENT APPLICATIONS

This application claims priority to Chinese Patent Application No. CN201610975132.5, filed Nov. 7, 2016, and Chinese Patent Application No. CN201620882958.2, filed Aug. 16, 2016, and contents of both applications are hereby incorporated by reference in their entirety.

### TECHNICAL FIELD

The present invention relates to an intelligent dual output driver for brightness adjustment and color tuning a LED light module.

### BACKGROUND OF THE INVENTION

Currently there are three types of LED brightness-adjustment and color-tuning controls on the market:

1. Wireless control;

2. DALI wired control; and

3. DMX wired control.

In wireless control, a dedicated WIFI, Bluetooth, or ZIGBEE wireless communication chip is installed in an LED driver. A mobile phone dimming application software, or APP, through handshake connection and communication with dedicated wireless communication chip, achieves the brightness dimming and color tuning function. Wireless solution is expensive because of the stringent requirements for the LED driver market, and the R&D software cost for mobile phone Android platform or Apple iOS system.

In DALI wired dimming control, a DALI (Digital Addressable Light Interface) main controller uses DALI bus transfer protocol, DALI+/DALI−, to send relevant dimming and color control signals to an LED driver, which performs the brightness dimming and color tuning function based on the received relevant control signals on the DALI bus. In the DALI wired control solution, the need to match the DALI host controller involves a complex DALI control system and a complete DALI software code. The LED driver needs to have a DALI decoder control chip and this leads to complex technical solution and end-user operation.

In DMX (Digital Multiplex) wired control, a DMX main controller uses the DMX512 bus transfer protocol, DMX+/DMX−, to send relevant dimming and color control signals to an LED driver, which performs the brightness dimming and color tuning function based on the received relevant control signals on the DMX bus. DMX wired control solution needs to match the DMX host controller. Currently DMX host controllers on the market have difference specifications from different manufacturers. Because of the DMX control compatibility issues, the LED driver needs to have a DMX decoder control chip compatible with a DMX host controller. This leads to a complex technical solution and end-user operation.

### SUMMARY OF THE INVENTION

The present invention uses existing 0-10V dimmers on the market for the end-user to control the currents of a dual-output LED driver through a voltage conversion circuit.

According to the present invention, two constant-current driver circuits are used to provide two modulated-current signals to two LED modules arranged to output lights of different color temperatures. Each of the constant-current drivers receives a dc voltage from a dc power source and a pulse-width modulation (PWM) signal. The PWM signals, PWM1 and PWM2, are provided by a voltage-to-PWM converter, which uses a single-chip microcomputer or the like programmed to sample the output voltage of a variable voltage source to generate the PWM signals. The variable voltage source can be a single 0-10V dimmer or two 0-10V dimmers. One LED module is arranged to provide output light of 3000 K and one is arranged to provide output light 6500 K. The mixed light from the two LED modules has color temperatures between 3000 K and 6500 K depending on the ratio of PWM1:PWM2.

The voltage-to-PWM converter is programmed to provide the PWM signals in many combinations depending on how the variable voltage source is operated. For example, PWM1 and PWM2 can be generated independent from each other; PWM1 and PWM2 maintain a fixed relationship such that the sum of PWM1 and PWM2 is equal to 100%; or both PWM1 and PWM2 are allowed to change while maintaining a certain ratio of PWM1:PWM2. Thus, the variable voltage source can be used to adjust the brightness of the output light and/or adjust the color temperatures of the output light from the LED modules.

Thus, the first aspect of the present invention is a dual-output driver for use with a bi-color LED module, the bi-color LED module comprising a first LED module and a second LED module, the driver comprising:

a voltage-to-PWM converter configured to receive at least one voltage signal for providing a first PWM signal and a second PWM signal;

a first step-down constant-current circuit arranged to receive the first PWM signal for providing a first modulated current to the first LED module; and

a second step-down constant current circuit arranged to receive the second PWM signal for providing a second modulated current to the second LED module, wherein said at least one voltage signal is ranged from 0-10V.

According to an embodiment of the present invention, the first step-down constant-current circuit and the second step-down constant-current circuit are also arranged to receive a dc voltage signal and the first modulated current and the second modulated current are provided also based on the dc voltage signal.

According to an embodiment of the present invention, the at least one voltage signal comprises a first voltage signal and a second voltage signal, and the voltage-to-PWM converter configured to sample both the first voltage signal and the second voltage signal for providing the first PWM signal and the second PWM signal based on the first voltage signal and the second voltage signal, wherein each of the first voltage signal and the second voltage signal is ranged from 0-10V.

According to an embodiment of the present invention, the first PWM signal has a first PWM value ranged from 0% to 100% and the second PWM signal has a second PWM value ranged from 0% to 100%.

According to an embodiment of the present invention, the driver is operatively connected to a 0-10V dimmer for receiving said at least one voltage signal, the dimmer is configured to provide a continuously variable voltage in the range of 0-10V.

According to an embodiment of the present invention, the driver is operatively connected to a first 0-10V dimmer for receiving the first voltage signal and a second 0-10V dimmer for receiving the second voltage signal, each of the first and second dimmers is configured to provide a continuously variable voltage in the range of 0-10V.

According to an embodiment of the present invention, the 0-10 dimmer comprises a dimming control in a form of a turn knob or a slide key.

According to an embodiment of the present invention, each of the first and second dimmers comprises a dimming control in a form of a turn knob or a slide key.

According to an embodiment of the present invention, the at least one voltage signal comprises a first voltage signal and a second voltage signal, and the voltage-to-PWM converter configured to sample both the first voltage signal and the second voltage signal for providing the first PWM signal and the second PWM signal based on the first voltage signal and the second voltage signal, wherein each of the first voltage signal and the second voltage signal is ranged from 0-10V.

According to an embodiment of the present invention, the first PWM value and the second PWM value are independent from each other.

According to an embodiment of the present invention, the first PWM value and the second PWM value are arranged such that the sum of the first PWM value and the second PWM value is 100%.

According to an embodiment of the present invention, the first PWM value and the second PWM value are arranged such that that a ratio of the first PWM value to the second PWM value is a constant.

The second aspect of the present invention is a dual-out driver system comprising:

a variable voltage source arranged to provide at least one variable voltage signal;

a bi-color LED module comprising a first LED module and a second LED module, the first LED module arranged to output light in a first color temperature, the second LED module arranged to output light in a different second color temperature;

a voltage-to-PWM converter configured to receive at least one variable voltage signal for providing a first PWM signal and a second PWM signal;

a dc power source arranged to provide a constant dc voltage;

a first step-down constant-current circuit arranged to receive the first PWM signal and the constant dc voltage for providing a first modulated current to the first LED module; and

a second step-down constant current circuit arranged to receive the second PWM signal and the constant dc voltage for providing a second modulated current to the second LED module, wherein the variable voltage source comprises a 0-10V dimmer configured to provide a continuously variable voltage in a range of 0-10V.

According to an embodiment of the present invention, the first color temperature is substantially 3000 K and the second color temperature is substantially 6500 K.

According to an embodiment of the present invention, wherein the variable voltage source comprises a first 0-10V dimmer and a second 0-10V dimmer, each of the first and second dimmer configured to provide a continuously variable in a range of 0-10V.

According to an embodiment of the present invention, wherein the at least one variable voltage signal comprises a first variable voltage signal and a second variable voltage signal, and the voltage-to-PWM converter configured to sample both the first variable voltage signal and the second variable voltage signal for providing the first PWM signal and the second PWM signal based on the first variable voltage signal and the second variable voltage signal, wherein the variable voltage source comprises a 0-10V dimmer configured to provide a continuously variable voltage in a range of 0-10V.

### BRIEF DESCRIPTION OF THE DRAWINGS

FIG. 1 is a block diagram of a dual-output driver system for driving a bi-color LED module, according to embodiments of the present invention.

FIG. 2 is a block diagram showing the electrical components of the dual-output driver system, according to an embodiment of the present invention.

FIG. 3 is a block diagram showing the electrical components of the dual-output driver system, according to another embodiment of the present invention.

FIG. 4 is a block diagram showing the LED drivers for separately driving two LED modules, according to an embodiment of the present invention.

FIG. 5A shows the modulated-current output of one of the LED drivers, according to an embodiment of the present invention.

FIG. 5B shows the modulated-current output of another LED driver, according to another embodiment of the present invention.

FIG. 6 shows the current distribution between two LED modules, according to a different embodiment of the present invention.

FIG. 7A illustrates a prior art dimmer having a slide key for dimming control.

FIG. 7B illustrates another prior art dimmer having a turn knob configured as an on/off switch and a dimming control.

### DETAILED DESCRIPTION

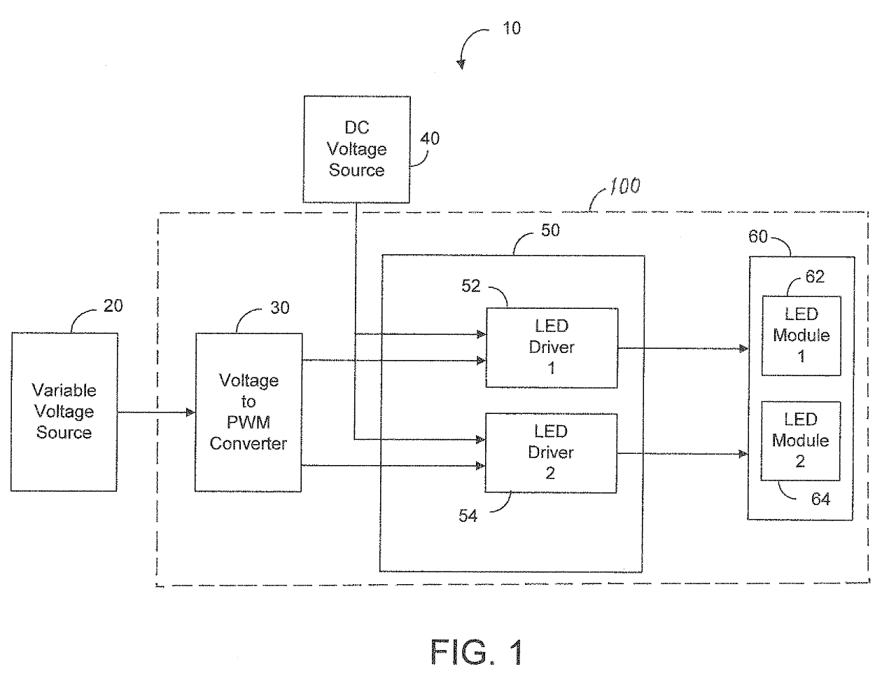

FIG. 1 is a block diagram of a dual-output driver system, according to an embodiment of the present invention. As seen in FIG. 1, the dual-output driver system 10 comprises a LED light-output controlling device 100. The light-output controlling device 100 comprises a voltage-to Pulse-Width Modulation (PWM) converter 30 and a dual-LED driver module 50. As seen in FIG. 1, a variable voltage source 20 arranged to provide a voltage signal to the voltage-to-PWM converter 30 which is configured to provide two PWM (pulse-width-modulation) signals 31, 33 to the dual-LED driver module 50. The dual-LED driver module 50 has a first LED driver 52 and a second LED driver 54 arranged to provide modulated currents 53, 55 to a bi-color LED module 60. A dc power source 40 is arranged to provide a dc voltage signal to the dual LED driver module 50. Based on the PWM signals and the dc voltage signal, the first and second LED drivers 52, 54 are configured to provide pulse-width modulated currents to the first LED module 62 and the second LED module 64 in the bi-color LED module 60.

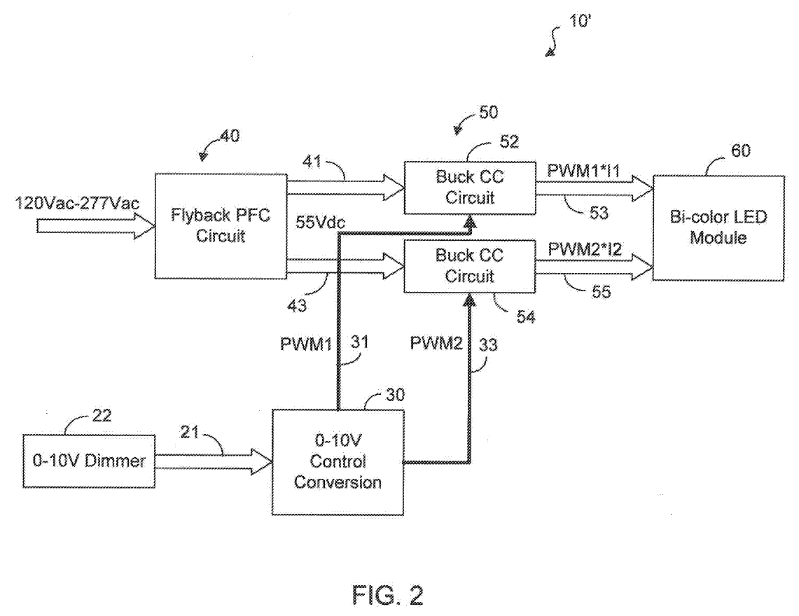

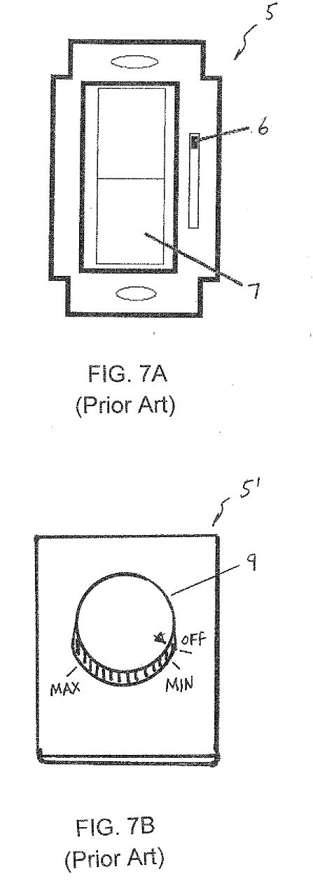

According to an embodiment of the present invention, the first LED module 62 and the second LED module 64 are arranged to output lights of different color temperatures. One is arranged to output light around 3000 K (warm yellow light) and the other around 6500 K (cold white light), for example. As seen in FIGS. 1 and 2, the variable voltage source 20 can a single 0-10V dimmer 22 configured to provide a single voltage output 21, or two dimmers: a first 0-10V dimmer 24 configured to provide a voltage output 23 and a second 0-10V dimmer 26 configured to provide a voltage output 25. It should be noted that each of the dimmers 22, 24 and 26 has an on-off switch and a slide key, and the functions of the on-off switch and the slide key are similar to the on-off switch 7 and the slide key 6 of a prior art dimmer 5 (FIG. 7A).

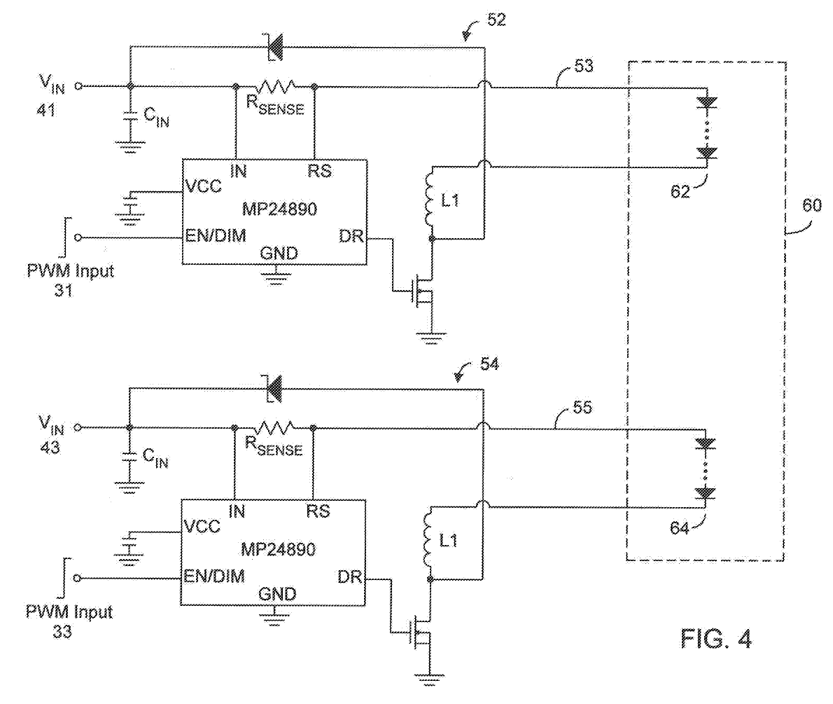

According to embodiments of the present invention, the voltage-to-PWM converter 30 is a 0-10V control conversion device which uses a single chip microcomputer programmed to sample the output voltage from the variable voltage source 20 and provides two different modulation pulse signals PWM1 and PWM2. The dc power source 40 can be a Flyback Power-Factor Correction (PFC) circuit, which is arranged to receive an ac voltage in the range of 120Vac to 277Vac and convert the ac voltage into a dc voltage 41, 43 of 55V, for example. Each of the first and second LED drivers 52, 54 can be a step-down Constant Current circuit (Buck CC Circuit) as shown in FIG. 4. Each of the step-down CC circuits 52, 54 has one input terminal (Vin) to receive an dc voltage signal and another input terminal (PWM input) to receive a PWM signal. Based on the dc voltage signal and the PWM1 and PWM2 signals, the first LED driver 52 provides a modulated-current signal PWM1*I1 to the first LED module 62; the second LED driver 54 provides a modulated current signal PWM2*I2 to the second LED module 64. In an embodiment of the present invention, the voltage-to-PWM convert 30 is effectively a 0-10V control conversion circuit. In an embodiment of the present invention, the LED light source in the first LED module 62 is arranged to provide 3000 K light output (warm light) and the LED light source in the second LED module 64 is arranged to provide 6500 K light output (cold light).

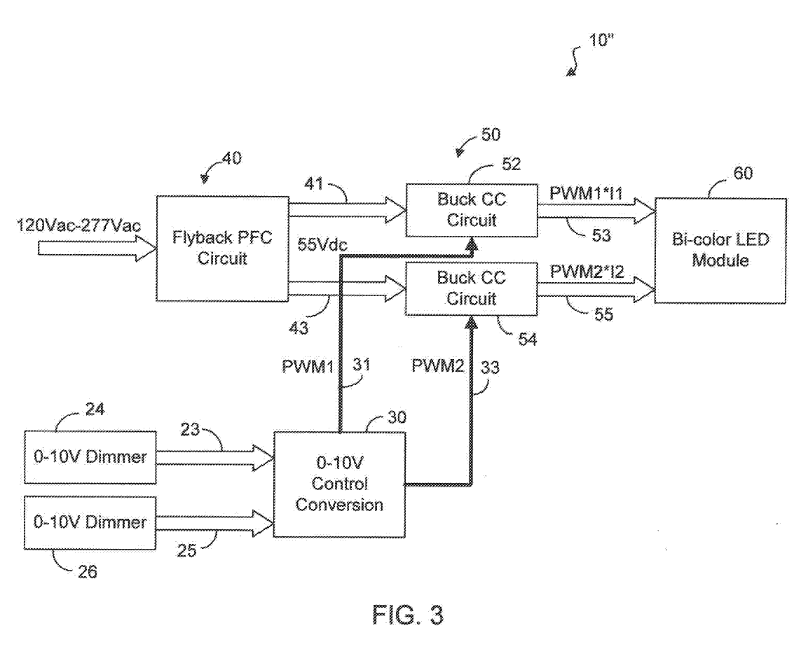

In an embodiment of the present invention, a single 0-10V dimmer 22 is used to provide a dc voltage signal 21 to the 0-10V control conversion circuit 30 as shown in FIG. 2. In another embodiment of the present invention, a first 0-10 dimmer 24 is used to provide a dc voltage signal 23 and a second 0-10 dimmer 26 to provide a dc voltage signal 25 to the 0-10V control conversion circuit 30 as shown in FIG. 3. In an embodiment of the present invention, each of the 0-10V dimmers 22, 24, 26 has an on-off switch and a slide key similar to the on-off switch 7 and the slide key 6 of a prior art dimmer 5 as shown in FIG. 7A.

In general, a user must turn the on-off switch on and move the slide key on the dimmer to provide a 0-10V dc voltage signal to the 0-10V control conversion circuit 30 in order to control the light output from the bi-color LED module 60. Based on the 0-10V dc voltage signal from the dimmer, the 0-10V control conversion circuit 30 determined the value of PWM1 and PWM2. In FIG. 4, each of the step-down CC circuits 52, 54 is an MP24894 chip made by Monolithic Power System. However, a similar circuit can also be used.

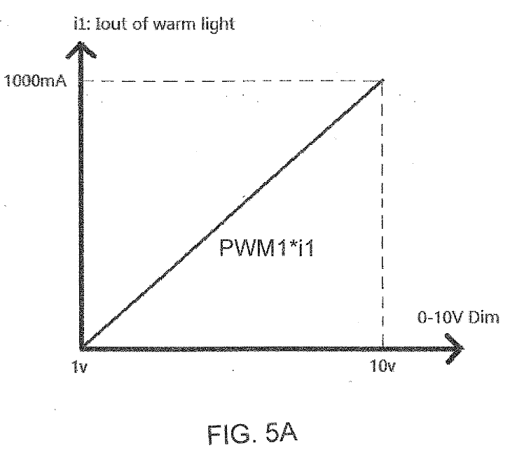

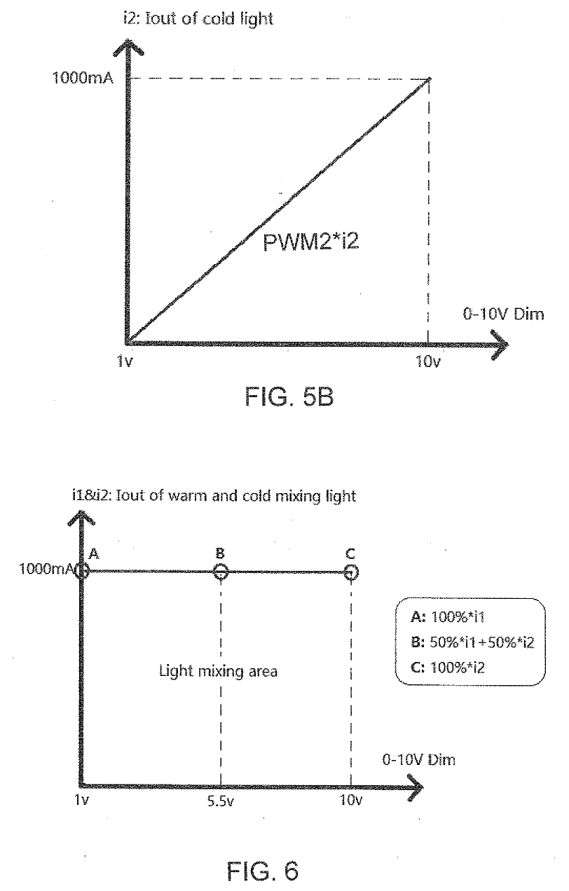

An exemplary plot of PWM1*I1 vs the dimmer voltage output is shown in FIG. 5A. As seen in FIG. 5A, when the dc voltage signal received by the 0-10V control conversion circuit 30 is 1V, the output PWM1*I1 of the first step-down CC circuit 54 is 0 mA; when the dc voltage signal received by the 0-10V control conversion circuit 30 is 10V, the output PWM1*I1 of the first step-down CC circuit 54 is 1000 mA. Similarly, a plot of PWM2*I2 vs the dimmer voltage output is shown in FIG. 5B. In some embodiments of the present invention, PWM1 and PWM2 are independent of each other. In some embodiments of the present invention, PWM1+PWM2=100%, and the current distribution between the first and second LED modules 62 and 64 is shown in FIG. 6.

According to an embodiment of the present invention, the 0-10V dimmer is a dimmer configured to provide a 0-10V continuous variable voltage. The dimmer comprises a dimming control in a form of a slide key or a turn knob.

### Single-Dimmer Operations

The present invention can be carried out in a number of modes. For example, in the embodiment as shown in FIG. 2, three modes can be carried out as follows:

1) only PWM1 from 0% to 100% is provided to the first CC circuit 52 in order to generate a current PWM1*I1 for driving the first LED module 62 (3000 K warm light source) as shown in FIG. 5A, while PWM2 is 0%.

2) only PWM2 from 0% to 100% is provided to the second CC circuit 54 in order to generate a current PWM2*I2 for driving the second LED module 64 (6500 K cold light source) as shown in FIG. 5B, while PWM1 is 0%.

3) PWM1 and PWM2 are provided to the first and second CC circuits 52, 54 at the same time with the total duty cycle PWM1+PWM2=100% in order to produce a mixed light of cold and warm colors as shown in FIG. 6. In this mode, when the sampling voltage changes from 1V to 10V, PWM1 changes from 100% to 0% and PWM2 changes from 0% to 100%. As a result, the color temperature of the mixed light gradually changes from 3000 K to 6500 K and the function of color tuning is achieved.

In an embodiment of the present invention, the control conversion circuit 30 is programmed to operate the light control is follows:

A) If the on-off switch of the dimmer 22 is turned on the first time, the bi-color LED module 60 is configured to provide a warm yellow (3000 K) color light, and the slide key can be used to change the brightness of the output light—for brightness dimming (see FIG. 5A);

B) If the on-off switch of the dimmer 22 is turned off and then on the second time, the bi-color LED module 60 is configured to provide a cold white (6500 K) color light, and the slide key can be used to change the brightness of the output light (see FIG. 5B);

C) If the on-off switch of the dimmer 22 is turned off and on the third time, the bi-color LED module 60 is configured to provide a mixed light of warm and cold colors and the slide key is used to change the color temperatures continuously from 3000 K to 6500 K, as shown in FIG. 6.

D) If the on-off switch of the dimmer 22 is turned off and on the fourth time, the effect is the same as procedure A above, and afterward, the procedures repeat themselves as described above.

Thus, although there is only a single dimmer 22 in the dual-output driver, the user can achieve brightness dimming of warm yellow light using the procedure A; the user can achieve brightness dimming of cold white light using the procedure B; and the user can achieve “stepless” color tuning using the procedure C.

### Dual-Dimmer Operations

In the embodiment as shown in FIG. 3, the first dimmer 24 can be used for color tuning and the second dimmer 26 can be used for brightness adjustment control. For example, the color temperatures of the light output from the bi-color LED module 60 can be caused to change gradually from warm yellow light (3000 K) to cold white light (6500 K) by moving the slide key of the first dimmer 24 from bottom to top. The light output from the bi-color LED module 60 can be caused to change from dim to bright by moving the slide key of the second dimmer 26 from bottom to top. According to an embodiment of the present invention, the operation of the two dimmers can be carried out as follows:

1) If the on-off switch of either the dimmer 24 or the dimmer 26 is off, there is no light output from the bi-color LED module 60. In other words, the bi-color module 60 can provide light output only when both the first dimmer 24 and the second dimmer 26 are turned on.

2) When both dimmers 24 and 26 are turned on and the slide key of the first dimmer 24 is moved to a certain position to set the color temperature, the slide key of the second dimmer 26 can be used to control the brightness of the light output from the bi-color LED module 60. For example, when the output light has been tuned to a color temperature of 4000 K, the slide key of the second dimmer 26 can be moved to cause the brightness of the output light from 10% to 100%.

3) When both dimmers 24 and 26 are turned on and the slide key of the second dimmer 26 is moved to a certain position to set the brightness of the light output from the bi-color LED module 60, the slide key of the first dimmer 24 can be used to change the color temperature of the output light. For example, when the output light has been adjusted by the second dimmer 26 to a certain brightness, such as 100% output, the slide key of the first dimmer 24 can be moved to cause the color temperature of the output light to change from 3000 K to 6500 K.

In the above operation, the color temperatures can be adjusted in a “stepless” fashion.

In a different embodiment of the present invention, the brightness and color temperature adjustment can be carried out with one of the dimmers 24, 26. For example, the off-on switch and the slide key of the dimmer 24 alone can be used to adjust both the color temperature and the brightness of the output light. For example, the color temperature can be adjusted by the number of on-off action (of the on-off switch) and the brightness can be adjusted by the position of the slide key. The control conversion circuit 30 is programmed to operate the light control is follows:

A) If the on-off switch of the dimmer 24 is turned on the first time, the bi-color LED module 60 is configured to provide a warm yellow (3000 K) color light; the brightness of the yellow light can be adjusted by moving the slide key.

B) If the on-off switch of the dimmer 24 is turned off and then on the second time, the bi-color LED module 60 is configured to provide a mixed light of 4000 K; the brightness of the mixed light can be adjusted by moving the slide key.

C) If the on-off switch of the dimmer 24 is turned off and on the third time, the bi-color LED module 60 is configured to provide a mixed light of 5000 K; the brightness of the mixed light can be adjusted by moving the slide key.

D) If the on-off switch of the dimmer 24 is turned off and on the fourth time, the bi-color LED module 60 is configured to provide the cold white light of 6500 K; the brightness of the white light can be adjusted by moving the slide key.

E) If the on-off switch of the dimmer 24 is turned off and on the fifth time, bi-color LED module 60 is configured to provide the warm yellow light of 3000 K as in Step A above, and the procedure repeats itself as described above.

Thus, using one of the dimmers in the dual-output driver, the user can select one of the four color temperatures: 3000 K, 4000 K, 5000 K, and 6500 K, and, at the same time, is able to adjust the brightness of the light output.

In one of the embodiments as described above, the brightness of the warm light (3000 K) is determined by PWM1 and the brightness of the cold light (6500 K) is determined by PWM2. The color temperature of the mixed light is determined by the ratio between PWM1 and PWM2. For example, to achieve a mixed light with a color temperature of 4000 K, the ratio PWM1/PWM2=11/9. With the mixed light of 4000 K, the brightness of the light output from the bi-color LED module 60 can be adjusted by adjusting the value of PWM1 and the value of PWM2 while keep the ratio of 11/9 the same.

Each of the 0-10V dimmers 22, 24, 26 can be a dimmer 5 having an on/off switch 7 and a slide key 6 for dimming control as shown in FIG. 7A, or a dimmer 5′ having a turn knob 9 configured as an on/off switch and a dimming control as shown in FIG. 7B, or having a turn knob for dimming and a separate on/off switch.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A dual-output driver for use with a bi-color LED module, the bi-color LED module comprising a first LED module and a second LED module, said driver comprising:
a voltage-to-PWM converter configured to receive at least one voltage signal for providing a first PWM signal and a second PWM signal;
a first step-down constant-current circuit arranged to receive the first PWM signal for providing a first modulated current to the first LED module; and
a second step-down constant current circuit arranged to receive the second PWM signal for providing a second modulated current to the second LED module, wherein said at least one voltage signal comprises a continuously variable voltage ranged from 0-10V.

2. The dual-output driver according to claim 1, wherein the first step-down constant-current circuit and the second step-down constant-current circuit are also arranged to receive a dc voltage signal and the first modulated current and the second modulated current are provided also based on the dc voltage signal.

3. The dual-output driver according to claim 2, wherein said at least one voltage signal comprises a first voltage signal and a second voltage signal, and the voltage-to-PWM converter configured to sample both the first voltage signal and the second voltage signal for providing the first PWM signal and the second PWM signal based on the first voltage signal and the second voltage signal, wherein each of the first voltage signal and the second voltage signal comprises a continuously variable voltage ranged from 0-10V.

4. The dual-output driver according to claim 2, wherein the first PWM signal has a first PWM value ranged from 0% to 100% and the second PWM signal has a second PWM value ranged from 0% to 100%.

5. The dual-output driver according to claim 1, wherein the driver is operatively connected to a 0-10V dimmer for receiving said at least one voltage signal, the dimmer configured to provide the continuously variable voltage in the range of 0-10V.

6. The dual-output driver according to claim 3, wherein the driver is operatively connected to a first 0-10V dimmer for receiving the first voltage signal and a second 0-10V dimmer for receiving the second voltage signal, each of the first and second dimmers configured to provide a continuously variable voltage in the range of 0-10V.

7. The dual-output driver according to claim 5, wherein the 0-10V dimmer comprises a dimming control in a form of a turn knob or a slide key.

8. The dual-output driver according to claim 6, wherein each of the first and second dimmers comprises a dimming control in a form of a turn knob or a slide key.

9. A dual-out driver system comprising:
a variable voltage source arranged to provide at least one variable voltage signal;
a bi-color LED module comprising a first LED module and a second LED module, the first LED module arranged to output light in a first color temperature, the second LED module arranged to output light in a different second color temperature;
a voltage-to-PWM converter configured to receive at least one variable voltage signal for providing a first PWM signal and a second PWM signal;
a dc power source arranged to provide a constant dc voltage;
a first step-down constant-current circuit arranged to receive the first PWM signal and the constant dc voltage for providing a first modulated current to the first LED module; and
a second step-down constant current circuit arranged to receive the second PWM signal and the constant dc voltage for providing a second modulated current to the second LED module, wherein the variable voltage source comprises one or two a 0-10V dimmers, each dimmer configured to provide a continuously variable voltage in a range of 0-10V.
